(19) United States
(12) Patent Application Publication
(10) Pub. No.: US 2006/0171363 A1
(43) Pub. Date: Aug. 3, 2006

(54) Wireless Transfer of Digital Video Data

(75) Inventors: Judite C. Xavier, Shrewsbury, MA (US); Elsa M. Carvalho, Sudbury, MA (US)

Correspondence Address: JUDITE C. XAVIER, 7 HAWTHORNE RD, SHREWSBURY, MA, 01545, US

(73) Assignees: Judite C. Xavier, Shrewsbury, MA (US); Elsa M. Carvalho, Sudbury, MA (US)

(21) Appl. No.: 10/906,071

(22) Filed: Feb. 2, 2005

(51) Int. Cl. H04Q 7/24

(52) U.S. Cl. 370/338; 370/401

(57) ABSTRACT

Improved methods and apparatuses are provided for wireless transfer of digital video from a Digital Video Recorder (DVR) to a Video Hosting Device (VHD). The wireless transfer can be performed over a plurality of wireless communication links, depending on transceiver used. The DVR may be factory-equipped with a wireless transceiver which is compliant with a high-throughput wireless standard, or alternatively, the DVR may have a media slot that supports a pluggable wireless transceiver card. Upon detection of a wireless network, the DVR's transceiver initiates a session to transfer digital video over the wireless communication link to the VHD. The VHD is typically a personal computer (PC), but can also be other devices or even third-party, possibly web-hosted, applications.

### BACKGROUND OF THE INVENTION

The present invention relates generally to digital video records (DVR), and more particularly to methods and apparatuses for transferring (downloading) digital video data from a DVR to a video hosting device (VHD) using a wireless communication link.

A conventional DVR is configured to capture video images, convert it to digital format, and store/record it to industry-standard media such as tape (Digital8, DV), optical disc (DVD), or solid-state memory. To playback the digital video from the physical media, the same or similar DVR is required and is typically connected to a display device (such as a television) over a physical cable.

However, for subsequent video editing, long-term storage, or other multi-media applications (such as email), it becomes necessary to transfer the digital video data from the original physical media to a storage/editing device such as a personal computer (PC). Conventionally, this is accomplished via some form of physical connectivity such as a universal serial bus (USB) cable or a FireWire (IEEE 1394) cable. If the DVR uses optical or solid-state media for digital video storage, then the PC may have a compatible port/slot to facilitate the transfer. Either method can be lengthy, cumbersome, and discouraging to the average non-technical DVR consumer.

In addition to the above drawbacks, there are other disadvantages with conventional methods and apparatuses for transferring digital video data. A few include: (a) Logistics and cost of running and matching cables with ports. (b) Maximum data volume, and hence time limitations, on the physical media. (c) Security and durability of the physical media. (c) Diversity and cost of physical media.

Thus, for these reasons and others, there is a need for improved methods and apparatuses for transferring digital video data from a digital video recorder (DVR) to a video hosting device (VHD). The present disclosure provides such a solution.

### SUMMARY OF THE INVENTION

In accordance with certain aspects of the present invention, improved methods and apparatuses are provided for transferring digital video data from a digital video recorder (DVR) to a video hosting device (VHD) over a wireless communication link.

Thus, for example, in accordance with certain implementations of the present invention, the system for wireless transfer of digital video data includes a digital video recorder (DVR), a wireless transceiver build into the DVR (internal) or on-board a media card plugged into a DVR media port (external), an available wireless network with a receiving transceiver, and a video hosting device (VHD).

The corresponding method includes logic within the DVR configured to transmit digital video data via the wireless transceiver to the VHD, and logic within the VHD to receive and archive the incoming digital video data. In the event where the wireless communication link is established with a commercial wireless network, the system also includes necessary subscriber privileges to communicate and transmit over the wireless service provider's network. Today, for example, this is typically true for commercial wireless networks based on GSM and CDMA derivatives, but not typically true for home/office wireless networks based on IEEE 802.11.

These and other aspects, features and advantages of the present disclosure will become apparent from the following description of exemplary embodiments, which is to be read in connection with the accompanying drawings.

### BRIEF DESCRIPTION OF DRAWINGS

A more complete understanding of the present invention may be had by reference to the following detailed description when taken in conjunction with the accompanying drawings wherein:

FIG. 1 depicts a block diagram of an exemplary embodiment of a digital video recorder (DVR) with an internal (factory-equipped) wireless transceiver for a plurality of wireless communication links, in accordance with the principles of the present disclosure.

FIG. 2 depicts a block diagram of an exemplary embodiment of a digital video record (DVR) with an external (pluggable media card) wireless transceiver for a plurality of wireless communication links, in accordance with the principles of the present disclosure.

FIG. 3 depicts a schematic diagram of an exemplary embodiment of the complete system having a transceiver-enabled DVR transfer digital video data to a plurality of different video hosting devices (VHD) over a plurality of different wireless communication links, in accordance with the principles of the present disclosure.

FIG. 4 shows an exemplary flow diagram depicting the improved method for processing the wireless transfer of digital video data from a transceiver-enabled DVR to a video hosting device (VHD), in accordance with the principles of the present disclosure.

### DETAILED DESCRIPTION OF PREFERRED EMBODIMENTS

To enable the method of transferring digital video data from a DVR to a VHD over a wireless communication link, in accordance with the principles of the present disclosure, a traditional conventional digital video recorder (DVR) requires a wireless transceiver (either internal or external) plus supporting logic to manage the wireless transfer process.

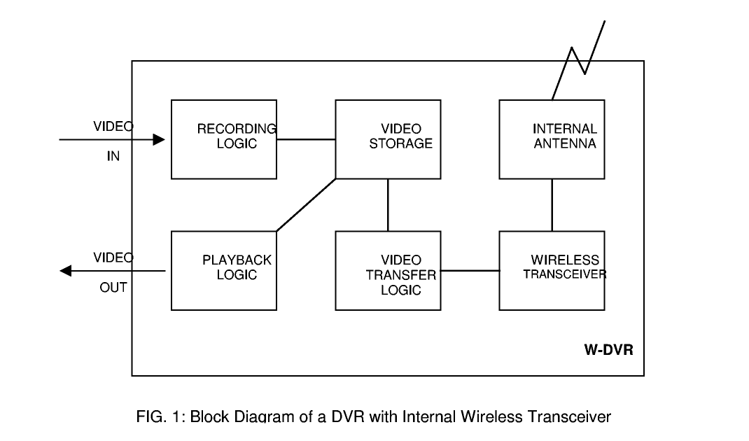

In accordance with certain preferred embodiments of the present invention, FIG. 1 depicts a DVR with an internal (factory-equipped) wireless transceiver. Henceforth, such an apparatus may be referred to as a Wireless Digital Video Recorder, or simply W-DVR. Note that functional and physical capabilities to record, store, and playback digital video are typical with conventional DVRs and are included in the W-DVR. Although not depicted in FIG. 1, other traditional and typical functions are also included, such as the video display, various ports, and power supply.

In accordance with the principles of the present disclosure, three significant functional components are added to the DVR, namely (a) Video Transfer Logic (VTL) to manage the wireless transfer process, (b) an internal wireless transceiver and (c) an internal antenna. Additionally, note that certain features of the conventional DVR will enhance the capabilities of the W-DVR. For example, video storage that is based on internal solid-state memory technology instead of removable media (such as tapes) facilitates access, transfer, and deletion of digital video data.

In accordance with certain preferred embodiments of the present invention, the wireless transceiver in the W-DVR may be configured to access any high-throughput wireless network. These networks may include, but not be limited, to: (a) wireless networks utilizing unregulated public spectrum and based on standards such as IEEE 802.11a/b/g; (b) second-generation (2G, 2.5G), third-generation (3G), or emerging fourth-generation (4G) commercial wireless networks; or (c) any other high-throughput wireless network requiring over-the-air communication between the DVR and the wireless network. Henceforth, in accordance with certain preferred embodiments of the present invention, the over-the-air communications channel between the DVR's transceiver and any such wireless network may be referred to as a wireless communication link, or simply a wireless link.

Note that all of the exemplary wireless network standards considered in the description of this invention (802.11, 3GSM, CDMA-EV, OFDM) support the transmission of data in packet form utilizing the Internet Protocol (IP). As those skilled in the art will confirm, this allows the W-DVR to have its own IP Address, effectively becoming another appliance on the network and simplifying digital video data transfers. However, in accordance with certain preferred embodiments of the present invention, IP communications is desired (especially over the wireless link), but not necessary.

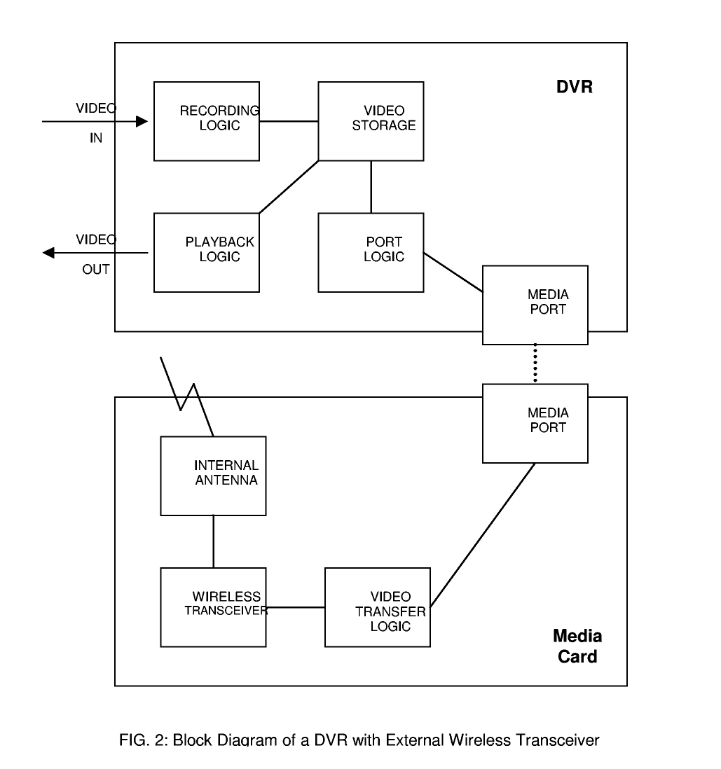

In accordance with certain preferred embodiments of the present invention, FIG. 2 depicts a DVR with an external (pluggable media card) wireless transceiver. Henceforth, such a combination of apparatus may be referred to as DVR-Plus-Card, or simply DVD+C. Unlike FIG. 1, the DVR depicted in FIG. 2 is effectively a typical and conventional DVR with typical functional and physical capabilities to record, store, and playback digital video. Other typical and conventional capabilities are included but not depicted, such as a display, various ports, and power supply. In accordance with the principles of the present disclosure, the wireless receiver, antenna, and associated video transfer logic (VTL) are housed (contained) in an external media card with physical and logical interfaces that are compliant with the DVR's media port.

Similar to FIG. 1 and in accordance with certain preferred embodiments of the present invention, the wireless transceiver in the media card may be configured to access a variety of wireless networks, as previously described. In particular, it is interesting to note that wireless transceivers in a media card form-factor already exist today for 802.11, UMTS, EV-DO, and OFDM wireless networks. These media cards comply with the PCMCIA form-factor and are targeted for the laptop computer market. In accordance with the principles of this disclosure, a DVR with a PCMCIA slot plus any of the above mentioned media cards would meet certain embodiments depicted in FIG. 2.

Note that, in accordance with certain preferred embodiments of the present invention, the media card need not necessarily comply with a single-casing form-factor. For example, the physical interface to the DVR's media port may be physically separated from to the main housing (casing) containing the wireless transceiver, the antenna, and the VTL. The physical interface may be connected to the main housing via a physical cable, or even wirelessly over Bluetooth, for example. This would be the case when using a typical mobile phone as the transceiver to establish the wireless link to the wireless network. Additionally, the physical interface need not necessarily be via the DVR's media port, but via any existing communication jack on the DVR such as USB 2.0 or IEEE 1394 (FireWire).

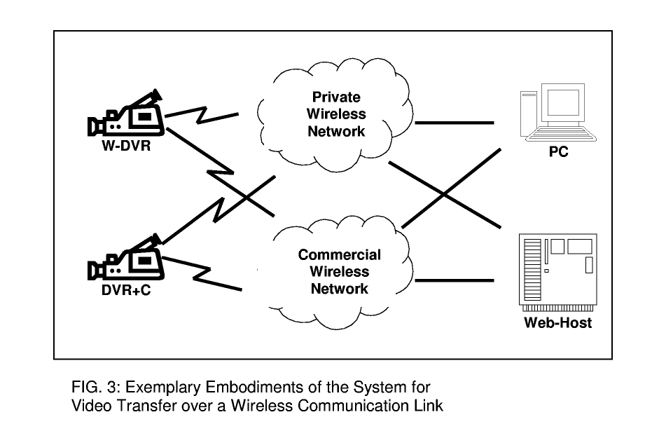

In accordance with certain preferred embodiments of the present invention, FIG. 3 depicts a schematic diagram of the complete system having a transceiver-enabled DVR (i.e. W-DVR or DVR+C) transfer digital video data to a plurality of difference video hosting devices (VHD) over a plurality of different wireless communication links.

Referring to FIG. 3, some exemplary embodiments of the present invention composes of a transceiver-enabled DVR, either a W-DVR or a DVR+C, communicating over a wireless link to either a private wireless network or a commercial wireless network, and configured to transfer digital video data to a video hosting device (VHD) such as a home or office personal computer, or a web-hosted data storage server.

Starting on the left side of the schematic diagram of FIG. 3, the transceiver-enabled DVR has already been discussed in significant detail. However, in accordance with certain preferred embodiments of the present invention, the W-DVR in one case, and the media card of the DVR+C in another case, must contain Video Transfer Logic (VTL). The VTL is responsible for monitoring the local video storage for new digital video, converting and compressing video prior to transmission (if that option has been selected), initiating packet transmission automatically based on schedule parameters configured by the user, receiving acknowledgement of transmission, and performing immediate or future clean/recycling of the local video storage space.

Continuing to move from left-to-right in the schematic diagram of FIG. 3, and focusing on the wireless link between the DVR and the wireless network, this represents an over-the-air interface with sufficient bandwidth to transmit DV-quality video. Preferable throughput of the air interface (i.e. the wireless link) is one-to-one or greater, implying that it would take one hour real-time to transmit one hour of digital video data. Higher transmit ratios are preferred, while substantially lower ratios start to become impractical. As an optional and exemplary embodiment of the present invention, the W-DVR or DVR+C can, prior to transmission, convert the digital video from DV format to MPEG-2 format, a well-established process familiar to those skilled in the art.

Today, a conventional consumer DVR generates digital video (including video, audio, and overhead) at roughly 36 Mbps (Megabits per second). Prior to transmission, this can optionally be converted to MPEG-2 at roughly 6 Mbps with no visible quality degradation. An IEEE 802.11b wireless network offers a theoretical throughput of 11 Mbps and an effective average throughput around 6 Mbps. In contrast, IEEE 802.11a and 802.11g wireless networks are capable of achieving average effective throughputs of 36 Mbps, providing a 1:1 transmission rate for DV-format video and a near 6:1 rate for MPEG-2 video.

Due to the volume of digital video data, practical embodiments of the present invention are only feasible on higher-throughput wireless networks. For reference, as those skilled in the art will confirm, the following are generally accepted average effective throughputs for various types of wireless networks: GSM GPRS ˜40 Kbps; CDMA 1xRTT ˜100 Kbps; GSM EDGE ˜200 Kbps; FLASH-OFDM ˜400 Kbps; GSM UMTS ˜1 Mbps; CDMA EV-DO/DV ˜1 Mbps; IEEE 802.11b ˜6 Mbps; IEEE 802.11a/g ˜36 Mbps.

As an optional embodiment of the present invention, the pre-transmitted digital video (DV) may be converted and/or compressed to a lower MPEG-2 quality such that the transmission ratio over a wireless network nears one-to-one. This would provide benefit to law enforcement, rescue, and monitoring applications, where some video, even low quality video, must be transmitted at or near real-time, while saving the higher quality video for transfer at a future time. In this case, video quality would be lower than consumer VHS. A DVR+C configuration is ideal for such an embodiment by having a commercial network media card in the field and an 802.11 media card in the office.

Continuing to move from left-to-right in the schematic diagram of FIG. 3, this disclosure proposes no additional method or apparatus relating to the actual transport network. As those familiar with the art will attest, many private 802.11 networks and commercial wireless networks have been deployed, are well understood, and documented elsewhere. Additionally, the connection between the network and the video hosting device (VHD) is Ethernet-based and is considered to be as part of the network.

Finally, at the far right of the schematic diagram in FIG. 3 are various video hosting devices (VHD). In accordance with certain preferred embodiments of the present invention, the VHD can be an office or home computer, a web-based video storage/hosting service, or some other network multi-media appliances such as a DVD burner, for example. Although not depicted, and consistent with exemplary embodiments of the present invention, each VHD contains the Video Management Logic (VML). The VML is responsible for receiving incoming video packet data and transmitting acknowledgements, uncompressing and converting the incoming video as applicable, and storing the digital video locally.

The Video Management Logic (VML) may also perform certain functions specific to its VHD type. For example, after receiving two hours of video, the VML on a personal computer may initiate a backup to DVD. The VML on a monitoring device may simply display the incoming digital video and discard it. The VML on a web-based server may send email reminders its subscribers of the newly available video for downloading or streaming.

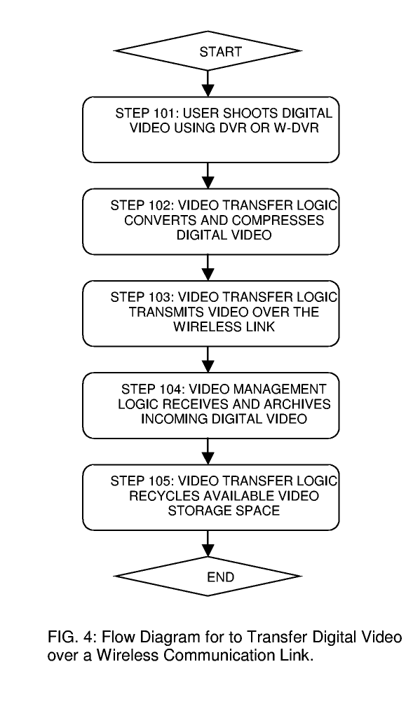

The detailed descriptions provided above describe primarily, but not exclusively, improvements to apparatuses required in preferred or exemplary embodiments of the present invention. FIG. 4, in accordance with certain preferred embodiments of the present invention, depicts a flow diagram highlighting improved methods to satisfy the wireless transfer of digital video data over a wireless communication link.

In Step 101 of the flow diagram in FIG. 4, the user shoots digital video with a conventional DVR or a W-DVR, per the conventional method. In the case of a W-DVR, the user is unaware of activities being performed internally by the Video Transfer Logic (VTL), although the user may have previously configured certain behavioral parameters, as described below.

In Step 102 of the flow diagram in FIG. 4, the Video Transfer Logic (VTL) decides the timing and process for transmission of the newly available digital video. In the case of the DVR+C configuration, the VTL will not become aware of the newly available video until the media card is connected to the DVR. For example, this may be common procedure for a consumer that usually leaves the IEEE 802.11 media card at home, or a journalist that usually leaves the 802.11 media card at the office, or a tourist that usually leaves the CDMA-EV media card in the hotel room.

When the newly available digital video has reached a minimum volume of data (60 seconds of video, for example), or a pre-defined time has elapsed since the oldest video frame was shot (60 minutes ago, for example), then the VTL begins preparation for transfer. Of course, the VTL must also wait until the internal transceiver detects the wireless network. Depending on the user's pre-defined configuration, the VTL may convert the video to MPEG-2 and compress it prior to transmission.

In Step 103 of the flow diagram in FIG. 4, the Video Transfer Logic (VTL) oversees the wireless transfer of digital video data to the VHD. Given that these are (likely) two IP devices communicating over an IP network, those skilled in the art will readily recognized that a protocol such as FTP (File Transfer Protocol) can easily perform the data transfer task, with the DVR/VTL acting as an FTP client and the VHD/VML as an FTP server. However, the VTL may also perform enhanced tasks, such as slowing packet transmission during daylight hours. Wireless service providers, in particular, will be interested in packet prioritization.

In Step 104 of the flow diagram in FIG. 4, the Video Management Logic (VML), resident on the VHD and acting in a fashion similar to an enhanced FTP server, receives and archives the incoming digital video. The digital video may also need to be uncompressed and converted, depending on the specific configuration of the VHD. Beyond these common functions, the VML may perform specific functions for specific VHDs.

Finally, in Step 105 of the flow diagram in FIG. 4, the Video Transfer Logic (VTL), resident in the W-DVR or the media card, makes decisions relating to the recycling of local video storage space. Any digital video that has been transmitted to (and acknowledged by) the VHD is eligible for deletion. In the case of a W-DVR, the VTL may keep 10% to 30% of total video storage space blank and available for recording. That is, when available storage space drops to 10%, the transfer logic deletes older video to bring availability up to 30%. In the case of a DVR+C, the VTL may have less frequent access to the video storage space, and may keep 30% to 50% of total video storage space blank and available for recording.

Although the illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope or spirit of the present disclosure. All such changes and modifications are intended to be included within the scope of the present disclosure as set forth in the appended claims.

What is claimed is:

1. A system for transferring digital video data from a wireless digital video recorder to a video hosting network device over a wireless communication link, the system comprising: (a) a wireless digital video recorder configured to capture, store, playback, and wirelessly transmit digital video data to the wireless communications network, and (b) a wireless communications network configured to receive digital video data from the wireless digital video recorder and forward it to the video hosting network device, and (c) a video hosting network device configured to receive digital video data from the wireless communications network and store it for subsequent processing.

2. A system as defined in claim 1, the wireless digital video recorder comprising: (a) a video capture subsystem configured to generate digital video data and forward it to the video storage subsystem, and (b) a video storage subsystem configured to save/store incoming digital video from the video capture subsystem and make it available to the video playback subsystem and the video transfer subsystem, and (c) a video playback subsystem configured to obtain digital video from the video storage subsystem and play it back through a digital display, and (d) a video transfer subsystem configured to obtain digital video from the video storage subsystem and transmit it wirelessly to a wireless communications network.

3. A system as defined in claim 2, the video transfer subsystem comprising: (a) a wireless transceiver kit (including antenna) configured to transmit digital video data to a wireless communications network, and (b) internal video transfer logic configured to periodically retrieve digital video data from the video storage subsystem and forward the digital video data to the wireless transceiver kit for onward wireless transmission to the wireless communication network, and (c) internal video purging logic configured to periodically recycle storage space in the video storage subsystem by purging the oldest digital video data that was already successfully transferred to the video hosting network device.

4. A system as defined in claim 3, with the video transfer subsystem completely contained by the main physical housing/casing of the wireless digital video recorder, including the wireless transceiver kit, the internal video transfer logic, and the internal video purging logic.

5. A system as defined in claim 3, with the video transfer subsystem partially or completely separated from the main physical housing/casing of the wireless digital video recorder, but physically and logically connected via a cable, media port, or communications jack.

6. A system as defined in claim 3, with the video transfer subsystem partially or completely separated from the main physical housing/casing of the wireless digital video recorder, but wirelessly and logically connected via a short-range wireless communication link.

7. A method for wireless transfer of digital video data from a wireless digital video recorder to a video hosting network device, the method comprising: (a) establishing a wireless communication link between the video transfer subsystem of the wireless digital video recorder and the video hosting network device; and (b) transferring the digital video data from the wireless digital video recorder to the video hosting network device over the wireless communication link using the wireless transceiver kit of the video transfer subsystem.

8. A method as defined in claim 7, further comprising capturing and saving/storing digital video data to the video storage subsystem of the wireless digital video recorder.

9. A method as defined in claim 7, further comprising preparing the digital video data for wireless transfer by compressing or converting the digital video to a more optimized transfer format.

10. A method as defined in claim 7, further comprising recycling storage space in the video storage subsystem by purging the oldest digital video data that has been successfully transferred to the video hosting network device.
